(19) United States
(12) Patent Application Publication
(10) Pub. No.: US 2015/0219504 A1
(43) Pub. Date: Aug. 6, 2015

(54) SENSOR AND METHOD FOR DETERMINING A TEMPERATURE

(71) Applicant: Siemens Aktiengesellschaft, Munich (DE)

(72) Inventors: Dieter Gotsch, Ottobrunn (DE); Richard Matz, Bruckmuhl (DE); Ruth Manner, Oberpframmern (DE)

(73) Assignee: Siemens Aktiengesellschaft, Munich (DE)

(21) Appl. No.: 14/421,817

(22) PCT Filed: Jul. 12, 2013
(86) PCT No.: PCT/EP2013/064788

§ 371 Date: Feb. 14, 2015

(30) Foreign Application Priority Data
Aug. 22, 2012 (DE) 10 2012 214 922.8

(51) Int. Cl. G01K 7/34

(52) U.S. Cl. CPC G01K 7/34

(57) ABSTRACT

A sensor for determining a temperature is provided, having a first insulating layer made of a first dielectric, which layer is arranged between a first and a second conductive layer made of a conductive material, and having a second insulating layer made of a second dielectric, which layer is arranged between the second and a third conductive layer made of a conductive material, wherein the first and the second dielectric have a different temperature dependency of the respective permittivity thereof. A method for determining a temperature by such a sensor is also provided.

The invention relates to a sensor and a method for determining a temperature.

High temperatures of hundreds of ° C. occur in many industrial processes, for example steel production, metal forming or the operation of gas turbines. Efficient control and robust operation of such processes necessitate an accurate measurement and control of the temperature.

So-called thermoelements composed of metal or metal oxides are usually used for temperature measurement in these temperature ranges. Such a thermoelement consists of two wires or conductor tracks that are brought into contact at the hot measurement location by crossing or soldering. The so-called thermovoltage can be tapped off at the cold end, said thermovoltage being characteristic of the material pairing and being dependent on the temperature difference between hot and cold sides of the thermoelement.

Whereas such thermoelements can be applied to different surfaces in a simple manner, for example by spray coating, they are nevertheless beset by a number of problems. On account of the dependence of the thermovoltage on a temperature difference, a reference temperature must always be provided in order to enable absolute temperature measurements. Since thermoelements are passive components, the sensitivity, the signal-to-nose ratio and the like cannot be influenced by external driving.

The present invention is therefore based on the object of providing a sensor and a method of the type mentioned in the introduction which allow a particularly simple, sensitive and reliable measurement of high temperatures.

This object is achieved by means of a sensor having the features of patent claim 1 and by means of a method having the features of patent claim 5.

A sensor according to the invention for determining a temperature comprises a first insulating layer composed of a first dielectric, said first insulating layer being arranged between a first and a second conductive layer composed of a conductive material. A second insulating layer composed of a second dielectric is arranged between the second and a third conductive layer composed of a conductive material. The temperature dependence of the electrical properties of this arrangement arises by virtue of the fact that the first and second dielectrics have a different temperature dependence of their respective permittivity.

In other words, in the context of the invention, a capacitive temperature sensor in the form of a two-layered capacitor is provided, which functions as a capacitive AC voltage divider.

In order to determine a temperature using such a sensor, as described in the context of the method according to the invention, a ratio of an input AC voltage applied between the first and the third conductive layer and an output AC voltage tapped off between the second and the third conductive layer is determined.

For a given geometry of the sensor and a given input AC voltage, the output AC voltage is dependent only on the capacitances between the first and second conductive layers and the second and third conductive layers. Said capacitances are in turn a function of the permittivities of the dielectrics and are thus directly dependent on the temperature.

In contrast to known thermoelements therefore, not just a temperature difference, but a direct measure of an absolute temperature is determined. The provision of a reference temperature can therefore be dispensed with, such that a particularly simple and precise measurement of high temperatures is made possible by means of the sensor and method according to the invention.

In order to provide a sensor which operates with little wear and stably under the high temperatures that are customary in many industrial processes, it is expedient to use oxide ceramics having high thermal stability for the dielectrics. In one preferred embodiment of the invention, therefore, aluminum oxide is used for the first dielectric and zirconium oxide is used for the second dielectric. Both oxides have sufficient thermal stability and differ greatly in the temperature dependence of their permittivities, such that a high accuracy of the temperature measurement can be ensured.

Metals, metal alloys or likewise thermally stable ceramics, such as doped indium tin oxide, for example, can be used for the conductive layers. All substance classes mentioned are likewise suitable for withstanding the high temperatures that are intended to be measured.

In order to ensure a particularly reliable temperature measurement, it is expedient to determine the ratio for different frequencies of the input AC voltage. This improves the measurement accuracy in particular in environments subjected to electromagnetic interference.

A contribution to improving the measurement accuracy is likewise made if the input AC voltage is chosen depending on a desired signal-to-noise ratio. In the case of particularly severe disturbances of the measurement, therefore, the quality can be significantly increased by the input AC voltage being increased.

In the simplest case, the temperature can be determined from the ratio between input AC voltage and output AC voltage by means of a corresponding characteristic curve which is specific for a given type of sensor and can be determined in a simple calibration measurement. An analytical evaluation is also possible if the exact temperature dependence of the permittivities of the two dielectrics is known.

The invention and its embodiments are explained in greater detail below with reference to the drawing, in which:

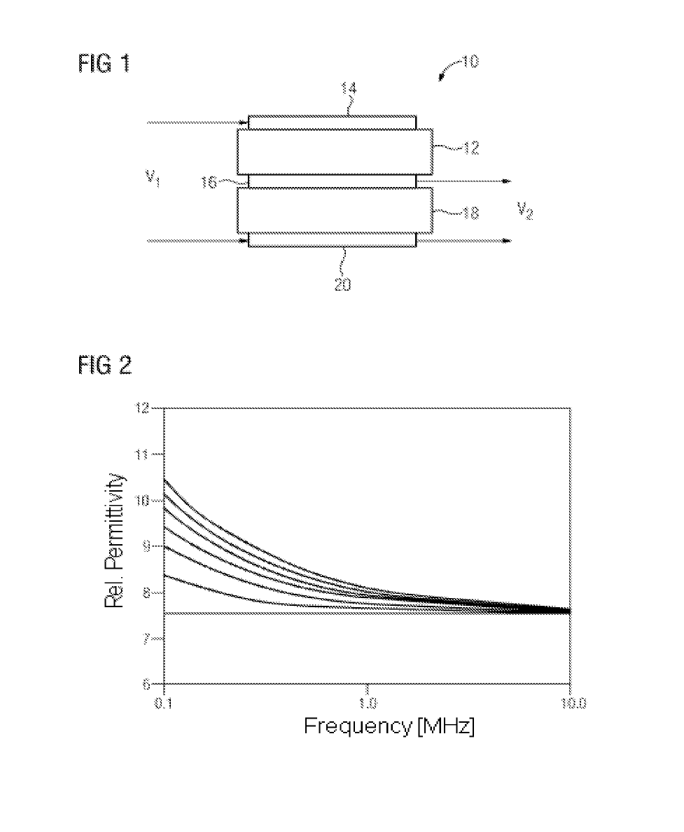

FIG. 1 shows a schematic sectional illustration through one exemplary embodiment of a sensor according to the invention;

FIG. 2 shows the temperature dependence of the permittivity of sintered aluminum oxide;

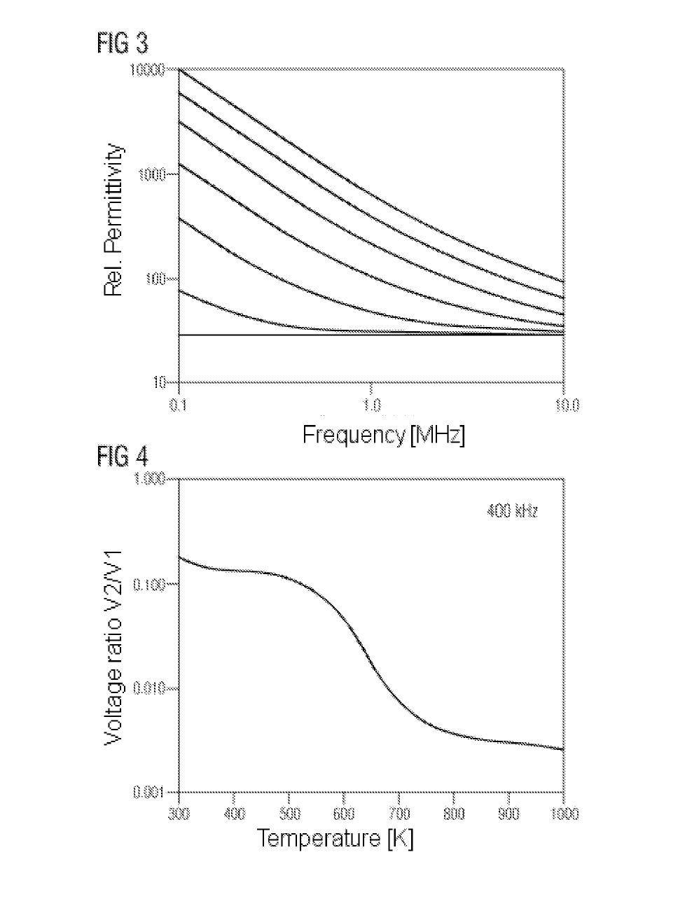

FIG. 3 shows the temperature dependence of the permittivity of sintered zirconium oxide;

FIG. 4 shows the temperature dependence of the ratio of input to output voltage of a sensor in accordance with FIG. 1 with the use of aluminum oxide and zirconium oxide as dielectrics.

A sensor for high-temperature measurements said sensor being designated in its entirety by 10, comprises a first dielectric 12, which is arranged between a first 14 and a second conductive layer 16, and also a second dielectric 18, which is arranged between the second and a third conductive layer 20.

The dielectrics are thermostable oxide ceramics, wherein the first and second dielectrics differ in terms of the temperature dependence of their permittivities. By way of example, sintered films composed of aluminum oxide and zirconium oxide can be used therefor. The conductive layers can consist of metals or metal alloys having a melting point chosen accordingly, or else of conductive ceramics, such as doped indium tin oxide, for example.

In order to carry out a temperature measurement by means of the sensor 10, an input AC voltage V₁ is applied between the first 14 and the third conductive layer 20 and an output AC voltage V₂ is tapped off between the second 16 and the third conductive layer 20.

The sensor 10 therefore acts as a capacitive AC voltage divider. The voltage ratio V₂/V₁, for a given sensor geometry and input AC voltage V₁, is dependent only on the capacitances between first 14 and second conductive layer 16 and between second 16 and third conductive layer 20. These capacitances are in turn a function of the permittivities of the dielectrics 12 and 18.

As shown in FIGS. 2 and 3, aluminum oxide (FIG. 2) and zirconium oxide (FIG. 3) have distinctly different permittivities and, moreover, a distinctly different temperature dependence of the permittivity. The figures in each case show the frequency response of the relative permittivity for seven different temperatures. The curves in each case show from the bottom to the top the behavior from 300 K to 900 K in 100 K steps.

As illustrated in FIG. 4, a distinct temperature dependence of the ratio of V₂/V₁ arises for each given frequency of the input AC voltage V₁. A sensor 10 having a capacitor area of 1 cm², a first dielectric 12 composed of a 106 μm thick zirconium oxide film and a second dielectric composed of a 165 μm thick aluminum oxide film was used in the case shown. It is clearly evident that the dependence of the voltage ratio on the temperature in the range of between 500 and 800 K exhibits a particularly great gradient. Consequently, the sensor 10 is particularly accurate in this temperature range.

Overall, therefore, a sensor 10 is provided which allows the measurement of absolute temperatures in high temperature ranges. Since it is possible to control the sensitivity by increasing the input AC voltage and by choosing the frequency of the input AC voltage, the sensor 10 is in particular also suitable for use in environments subjected to great electromagnetic interference.

1. A sensor for determining a temperature, comprising
a first insulating layer comprising a first dielectric, said first insulating layer between arranged between a first and a second conductive layer comprising a conductive material and
a second insulating layer comprising a second dielectric, said second insulating layer being arranged between the second and a third conductive layer comprising a conductive material,
wherein the first and second dielectric have a different temperature dependence of their respective permittivity.

2. The sensor as claimed in claim 1, wherein
the first dielectric is aluminum oxide.

3. The sensor as claimed in claim 1, wherein
the second dielectric is zirconium oxide.

4. The sensor as claimed in claim 1, wherein
the conductive layers comprise a metal, a metal alloy or a conductive ceramic.

5. A method for determining a temperature by means of a sensor as claimed in claim 1, wherein
a ratio of an input AC voltage (V1) applied between the first and the third conductive layer and an output AC voltage (V2) tapped off between the second and the third conductive layer is determined for the purpose of determining the temperature.

6. The method as claimed in claim 5, wherein
the ratio is determined for different frequencies of the input AC voltage (V1).

7. The method as claimed in claim 5, wherein
the input AC voltage (V1) is chosen depending on a desired signal-to-noise ratio.

8. The method as claimed in claim 5, wherein
the temperature is ascertained from the ratio by a characteristic curve.

9. The sensor as claimed in claim 4, wherein
the conductive layers comprise doped indium tin oxide.
